(19) United States
(12) Patent Application Publication
(10) Pub. No.: US 2008/0202305 A1
(43) Pub. Date: Aug. 28, 2008

(54) Fringe cutting tool

(76) Inventor: Karen Jean Jorgenson, Clarksville, TN (US)

Correspondence Address: Karen J. Jorgenson, 376 Velma's Way, Clarksville, TN, 37042, US

(21) Appl. No.: 11/804,766

(22) Filed: May 21, 2007

Related U.S. Application Data
(60) Provisional application No. 60/804,584, filed on Jun. 13, 2006.

(51) Int. Cl. B26D 5/08

(52) U.S. Cl. 83/523

(57) ABSTRACT

The invention is designed for quilting applications, and/or general sewing. It is an easy to use tool for cutting several evenly spaced slashes in single, or multi layers of fabrics thus making the fringing process much quicker and kinder on the hand than using just scissors alone.

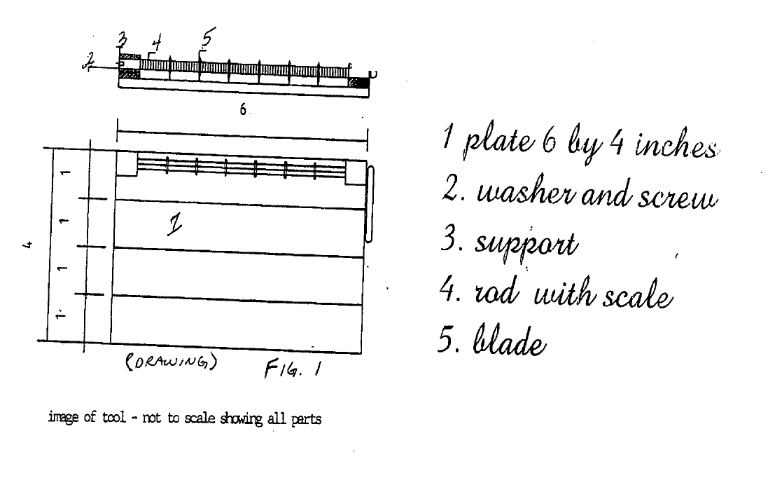

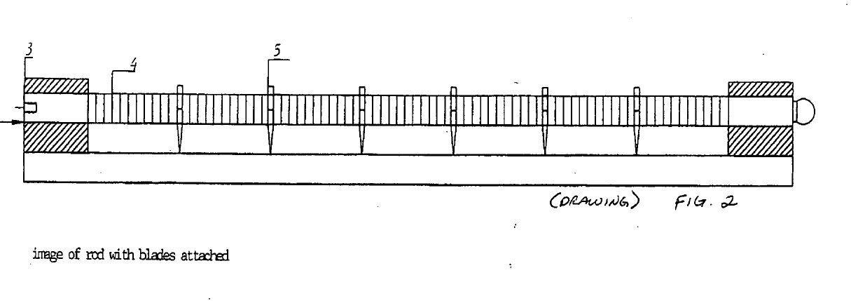

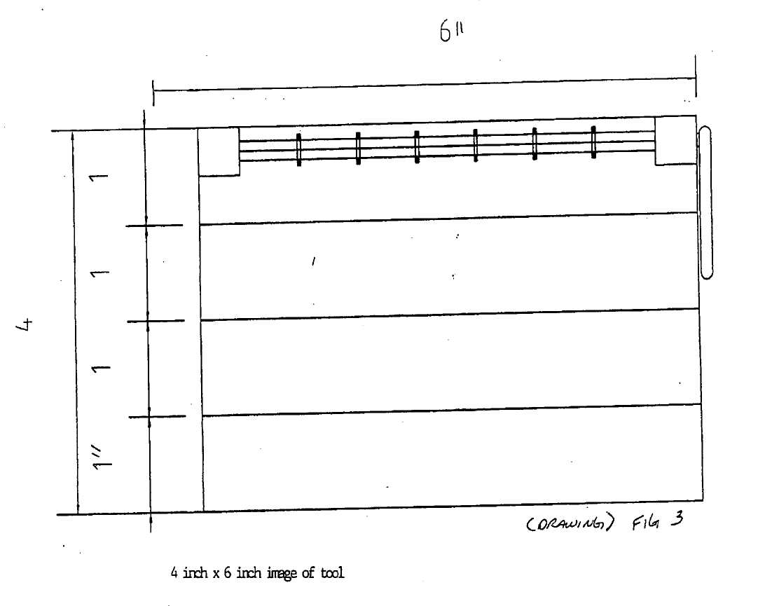

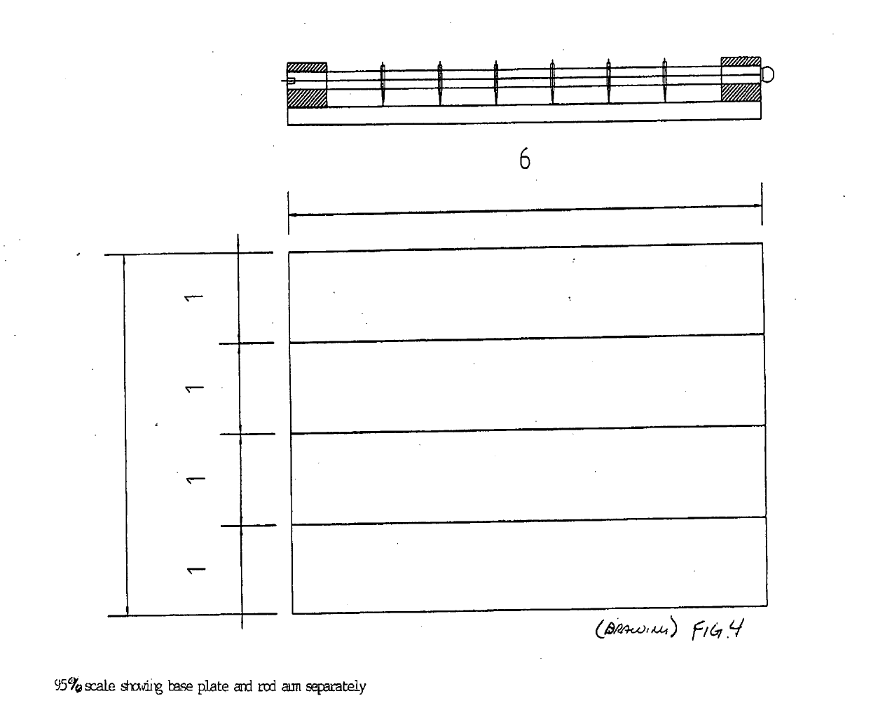

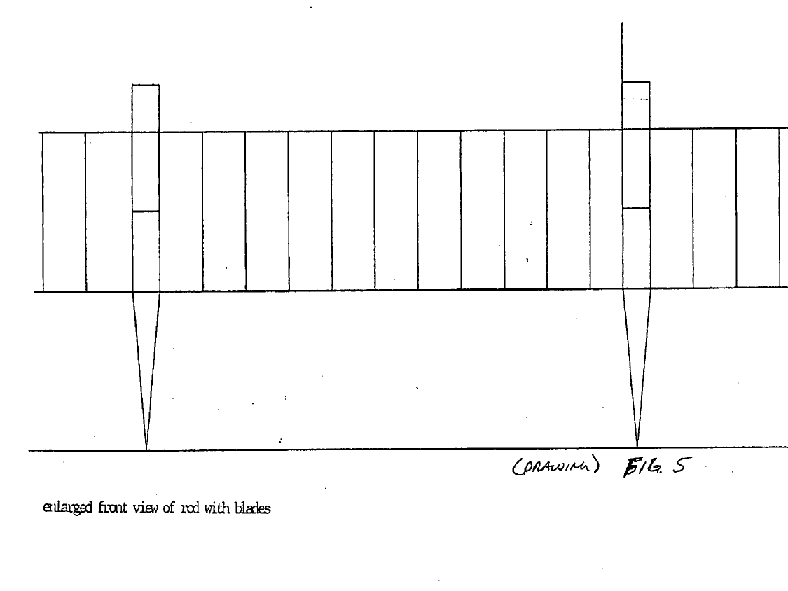

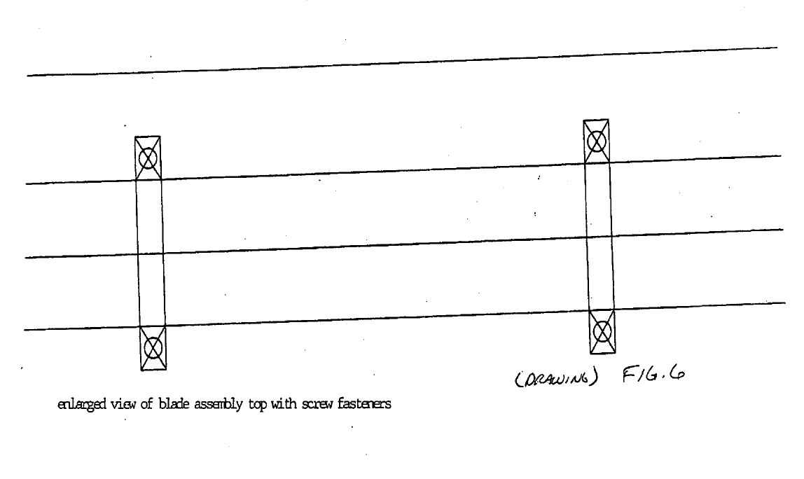

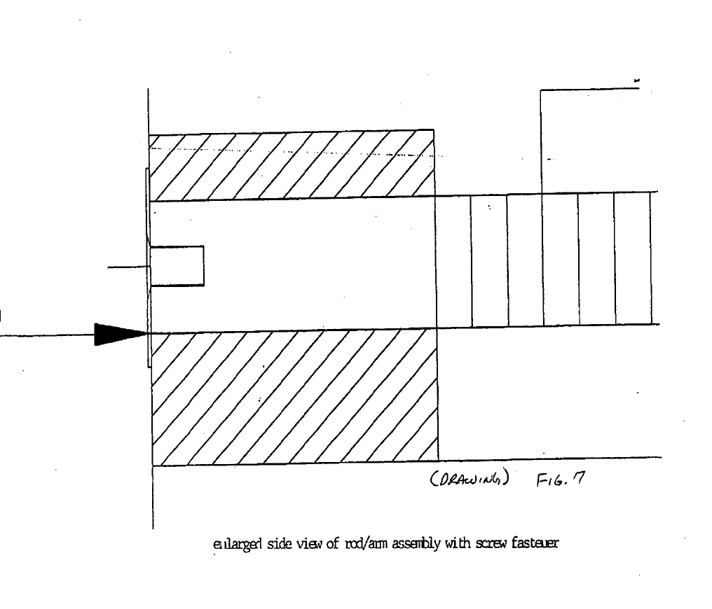

The present invention relates to a fringe cutting tool. The device is comprised of the following components:

Base plate on which the fabric is placed for cutting, marked out in fractions of inches for ease in measuring length of fringe to be cut, covered with a protective material so that blades will not be dulled striking the plate alone

Support arms—one on each end through which the rod and arm unit slide through—raised off the base plate to allow for fabric to slide in

Rod—has bolt tightening on one end of support arms to allow for rod to be removed—marked off in fractions of inches, for placement of blades

Blades—slide on rod with notched feature so blades are always correctly placed, and screw tighter on top so blades are secured to rod for use

Arm—used to lower blades into cutting position—has spring mechanism for ease of use.

### BRIEF DESCRIPTION OF DRAWINGS

Drawing 1: overall image of tool—not to scale, showing all parts

Drawing 2: enlarged view of rod with blades attached

Drawing 3: To scale image of tool

Drawing 4: to scale image showing base plate and rod arm separately

Drawing 5: enlarged front view of rod with blades

Drawing 6: enlarged view of blade assembly top with screw fasteners

Drawing 7: enlarged side view of rod/arm assembly with screw fastener

The support arms are permanently fixed to base plate, with holes drilled through to allow the rod and arm mechanism to slide through—rod and arm assembly is fixed to support arms with bolt tightening on one end (opposite of arm end of rod), blades are place on rod by inserting notch on blade with groove on rod and tightened into place with screw tighter on top, as the arm is moved down, the blades rotate down and cut through the fabric, fabric is place under blade assembly, and arm is lowered to bring blades down into cutting position and fabric is cut into evenly spaced fringes.

What is claimed is:

1. A fringe cutting tool that works by lowering an arm that is attached to a rod, having several blades attached. These blades, when lowered, will cut through the fabric, creating the fringe. The blades are movable so the distance between can be adjusted to make fringe of varying widths. Also, the platform is marked with inches so that fringe of varying lengths can be cut accurately.
